(19) United States
(12) Patent Application Publication
(10) Pub. No.: US 2026/0257548 A1
(43) Pub. Date: Sep. 3, 2026

(54) RETROFIT POWERTRAIN SYSTEMS AND APPARATUSES AND METHODS OF INSTALLING THE SAME

(71) Applicant: Toyota Tsusho America, Inc., Farmington Hills, MI (US)

(72) Inventors: Travis MALSTON, Farmington Hills, MI (US); Erik STAFL, South San Francisco, CA (US); Benjamin NG, South San Francisco, CA (US); Michael MULDOON, South San Francisco, CA (US)

(21) Appl. No.: 19/066,487

(22) Filed: Feb. 28, 2025

(51) Int. Cl. B60K 1/04; B60K 1/00; B60K 11/02; B60L 53/16

(52) U.S. Cl. CPC B60K 1/04; B60K 11/02; B60L 53/16; B60K 2001/005; B60K 2001/006

(57) ABSTRACT

A retrofit powertrain kit for a vehicle includes a first sub-assembly and a second sub-assembly. The first sub-assembly includes a motor and the second sub-assembly includes a battery and a power distribution unit. The first sub-assembly is configured to couple to a factory drivetrain of the vehicle. The power distribution unit is configured to couple the second sub-assembly to the first sub-assembly and is configured to provide power to the battery and one or more additional components of the vehicle.

### TECHNICAL FIELD

The present disclosure relates to retrofit powertrain kits, systems, and apparatuses and/or methods for installing retrofit powertrain kits in vehicles.

### BACKGROUND

Many existing vehicles are diesel or gas powered. Various regulatory changes are impacting emission standards in the airline industry and it is becoming desirable to have ground support equipment vehicles that are carbon neutral. Thus, there is a need for electrically powered ground support equipment vehicles.

### SUMMARY

At least one example embodiment relates to a retrofit powertrain kit for a vehicle. The retrofit powertrain kit may include a first sub-assembly including a motor and a second sub-assembly including a battery and a power distribution unit. The first sub-assembly may be configured to couple to a factory drivetrain of the vehicle. The power distribution unit may be configured to couple the second sub-assembly to the first sub-assembly and may be configured to provide power to the battery and one or more additional components of the vehicle.

In at least one example embodiment, the first sub-assembly may further include a parking brake. The first sub-assembly may be configured to couple to the factory drivetrain via the parking brake.

In at least one example embodiment, the retrofit powertrain kit may further include a coolant preconditioning system configured to cool at least a portion of the retrofit powertrain kit via liquid cooling.

In at least one example embodiment, the battery may include a controller configured to control the vehicle.

In at least one example embodiment, the retrofit powertrain kit may further include a first charging port; and a second charging port. The first charging port may be configured for DC charging and the second charging port may be configured for AC charging.

In at least one example embodiment, the power distribution unit may include a motor controller, a low voltage distribution unit, a high voltage distribution unit, and a charger.

In at least one example embodiment, the retrofit powertrain kit may further include at least one controller configured to determine an installation status of the retrofit powertrain kit within the vehicle.

In at least one example embodiment, the at least one controller may be configured to communicate with an interface to output an indication of the installation status of the retrofit powertrain kit within the vehicle.

In at least one example embodiment, the battery may be a high voltage battery and the retrofit powertrain kit may further include at least one low voltage battery configured to provide power to low voltage components of the vehicle.

Also described herein is a method of installing a retrofit powertrain kit into a vehicle. The method may include removing a preexisting engine of the vehicle, inserting a first sub-assembly of the retrofit powertrain kit into the vehicle, the first sub-assembly including a motor configured to couple to a factory drivetrain of the vehicle, and inserting a second sub-assembly of the retrofit powertrain kit into the vehicle, the second sub-assembly including a battery and a power distribution unit, the power distribution unit configured to power to the battery and one or more additional components of the vehicle.

In at least one example embodiment, the first sub-assembly of the retrofit powertrain kit may further include a parking brake.

In at least one example embodiment, inserting the first sub-assembly of the retrofit powertrain kit into the vehicle may include coupling the parking brake to the factory drivetrain.

In at least one example embodiment, the method may further include incorporating a coolant preconditioning system into the retrofit powertrain kit. The coolant preconditioning system may be configured to cool at least a portion of the retrofit powertrain kit via liquid cooling.

In at least one example embodiment, the method may further include charging the battery of the second sub-assembly via one of a first charging port or a second charging port. The first charging port may be an AC charging port and the second charging port may be a DC charging port.

In at least one example embodiment, the method may further include determining a status of installation of the retrofit powertrain kit within the vehicle.

In at least one example embodiment, the method may further include outputting the status of the installation of the retrofit powertrain kit.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a block diagram of a retrofit powertrain kit in accordance with at least one example embodiment.

FIG. 2 is a block diagram of a vehicle chassis including the retrofit powertrain kit of FIG. 1 in accordance with at least one example embodiment.

FIG. 3 is a diagram of a coolant preconditioning system of FIG. 1 in accordance with at least one example embodiment.

FIG. 4 is a flow chart of a method of installing a retrofit powertrain kit into a vehicle in accordance with at least one example embodiment.

### DETAILED DESCRIPTION OF EXAMPLE EMBODIMENTS

Some detailed example embodiments are disclosed herein. However, specific structural and functional details disclosed herein are merely representative for purposes of describing some example embodiments. Example embodiments may, however, be embodied in many alternate forms and should not be construed as limited to only example embodiments set forth herein.

Accordingly, while example embodiments are capable of various modifications and alternative forms, example embodiments thereof are shown by way of example in the drawings and will herein be described in detail. It should be understood, however, that there is no intent to limit an example embodiment to the particular forms disclosed, but to the contrary, example embodiments are to cover all modifications, combinations, equivalents, and alternatives falling within the scope of an example embodiment. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiment.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiment only and is not intended to be limiting of example embodiment. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements and/or groups thereof.

Example embodiments are described herein with reference to cross-sectional illustrations that are schematic illustrations of example embodiment. As such, variations from the shapes of the illustrations are to be expected. Thus, example embodiment should not be construed as limited to the shapes of regions illustrated herein but are to include deviations and variations in shapes.

When the words “about” and “substantially” are used in this specification in connection with a numerical value, it is intended that the associated numerical value include a tolerance of ±10% around the stated numerical value, unless otherwise explicitly defined. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiment belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The systems, apparatuses, kits, and methods described herein enable modification of existing diesel and gas powered vehicles to meet new regulatory standards without requiring the purchase of entirely new assets. In particular, there has been increasing pressure for airline, airport, and ramp service provider companies to create carbon neutral environments. Existing vehicles may not meet these new regulatory standards and also may be subject to increases in variable fuel pricing, periodic repair costs, and preventative maintenance. Further, existing vehicles may not meet newer safety standards and changing regulations that are being determined by the International Air Transport Association (IATA). The systems, apparatuses, kits, and methods described herein enable the conversion of existing chassis and assets to be repurposed from fuel combustion to electric powered. This conversion may enable older, existing vehicles to meet future IATA standards and/or other regulatory standards.

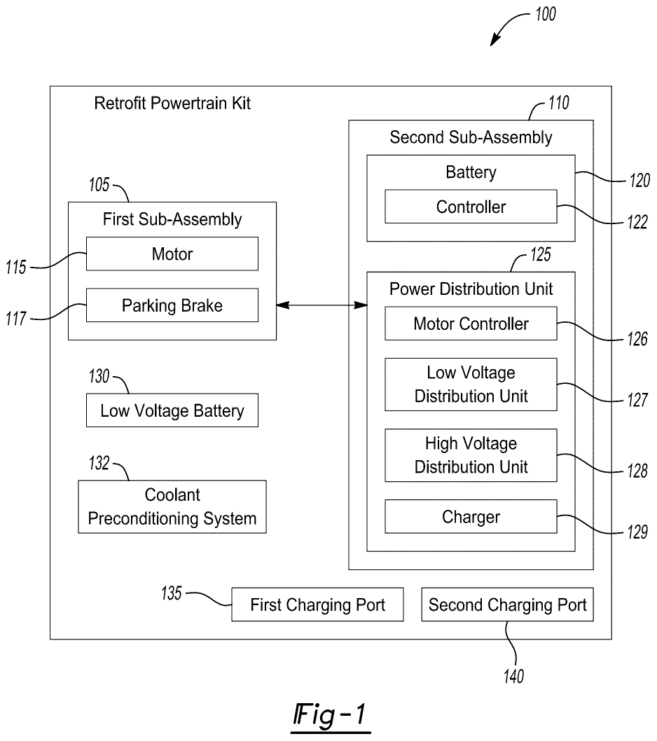

FIG. 1 is a block diagram of a retrofit powertrain kit 100 according to at least one example embodiment. The retrofit powertrain kit 100 includes a first sub-assembly 105 and a second sub-assembly 110.

The first sub-assembly 105 may include a motor 115 and a parking brake 117. In at least one example embodiment, the first sub-assembly 105 may be configured to couple to a factory drivetrain of a vehicle when the retrofit powertrain kit 100 is installed within the vehicle. In particular, the first sub-assembly 105 may be configured to couple to the factory drivetrain of a vehicle via the parking brake 117 according to at least one example embodiment.

The second sub-assembly 110 may include a battery 120 and a power distribution unit 125. In at least one example embodiment, the battery 120 may include a controller 122 configured to control the vehicle. In at least one example embodiment, the controller 122 may be configured to determine an installation status of the retrofit powertrain kit 100 within the vehicle. For example, the controller may be configured to communicate with an interface to output an indication of the installation status of the retrofit powertrain kit 100 within the vehicle. In particular, the controller 122 may be configured to output an indication of a faulty installation. The indication of the faulty installation may be output via one or more user interfaces such as a user interface on the vehicle including the retrofit powertrain kit 100 or on a user interface of a handheld or mobile device communicatively coupled with the vehicle and/or the retrofit powertrain kit 100. This indication may enable an operator to correct and/or update the installation to correctly fit the retrofit powertrain kit 100 into the vehicle. Outputting an indication of a faulty installation may help prevent unsafe operation of the vehicle including the retrofit powertrain kit 100. In at least one example embodiment, the retrofit powertrain kit 100 may include more than one controller. For example, a first controller may be configured to control the vehicle and a second controller may be configured to determine and/or communicate an installation status of the retrofit powertrain kit 100 within the vehicle.

The power distribution unit 125 may be configured to couple the second sub-assembly 110 to the first sub-assembly 105. In at least one example embodiment, the power distribution unit 125 may be configured to supply power to the battery 120 and one or more additional components of the vehicle. In at least one example embodiment, the power distribution unit 125 may include a motor controller 126, a low voltage distribution unit 127, a high voltage distribution unit 128, and a charger 129. The motor controller 126 may be configured to control the motor 115 of the retrofit powertrain kit 100. The low voltage distribution unit 127 may be configured to supply low voltage power to a low voltage battery 130 of the retrofit powertrain kit 100 and the high voltage distribution unit 128 may be configured to supply power to the battery 120. The charger 129 may be configured to charge one or more of the battery 120 and/or the low voltage battery 130.

In at least one example embodiment, the retrofit powertrain kit 100 may also include a coolant preconditioning system 132. The coolant preconditioning system 132 may be configured to cool or heat at least a portion of the retrofit powertrain kit 100. In at least one example embodiment, the coolant preconditioning system 132 may be configured to cool at least a portion of the retrofit powertrain kit 100 via liquid cooling. In at least one example embodiment, for cooling, an R134a refrigerant based 850W liquid chiller unit may be used to cool 50/50 propylene glycol/water (PGW) coolant through brazed aluminum cold plates. The coolant preconditioning system 132 may also be configured to heat at least a portion of the system. In at least one example embodiment, 1600W heating pads may be used which may be powered by the battery 120. The coolant preconditioning system 132 may also include over temperature protection and regulation with 60 degree Celsius positive temperature coefficient (PTC) ink.

In at least one example embodiment, the retrofit powertrain kit 100 may also include a first charging port 135 and a second charging port 140. In at least one example embodiment, at least one of the first charging port 135 or the second charging port 140 may be configured for direct current (DC) charging and the other of the first charging port 135 or the second charging port 140 may be configured for alternating current (AC) charging.

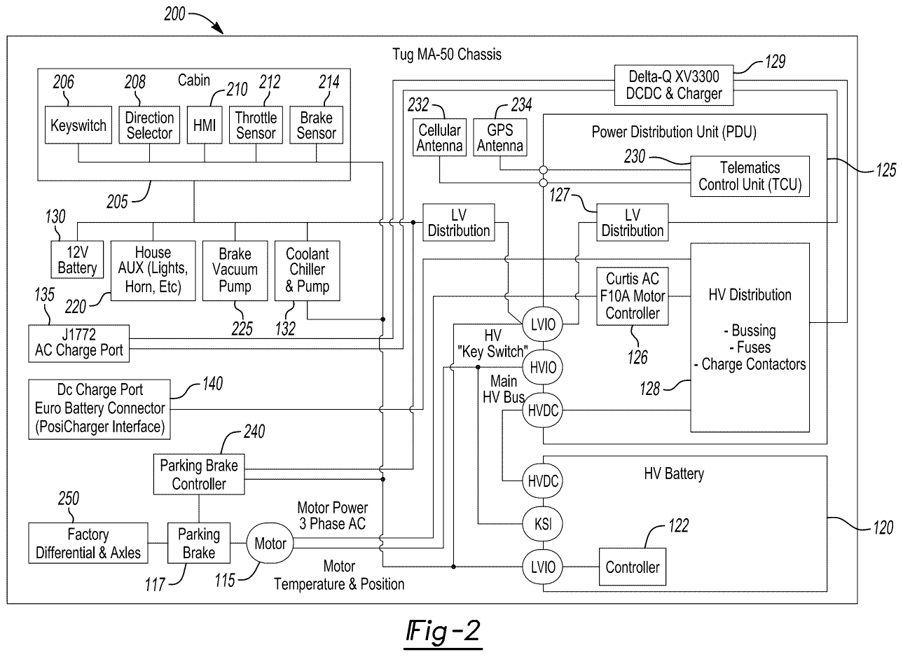

FIG. 2 is an example embodiment of a vehicle chassis 200 including the retrofit powertrain kit 100. In at least one example embodiment, the vehicle chassis 200 may include a cabin 205 of the vehicle. The cabin 205 may include at least a keyswitch 206, a direction selector 208, a human-machine interface (HMI) 210, a throttle sensor 212, and a brake sensor 214. Each of the components of the cabin 205 may be elements of the pre-existing vehicle. The cabin 205 may be coupled to at least the controller 122, the low voltage battery 130, and the power distribution unit 125 via the low voltage distribution unit 127. Thus, the low voltage battery 130 may be configured, with the low voltage distribution unit 127 of the power distribution unit 125, to provide power to the one or more elements of the cabin 205.

In at least one example embodiment, the low voltage battery 130 may be configured, with the low voltage distribution unit 127 of the power distribution unit 125, to provide power to additional components of the vehicle chassis 200 and/or the retrofit powertrain kit 100 such as auxiliary components 220 such as a horn or lights of the vehicle, a brake vacuum pump 225, and/or the coolant preconditioning system 132.

In at least one example embodiment, the power distribution unit 125 may additionally include a telematics control unit 230. The telematics control unit 230 may be configured to communicate with one or more of a cellular antenna 232 or a global positioning system (GPS) antenna 234.

As described above, the power distribution unit 125 may couple the second sub-assembly 110 to the first sub-assembly 105 via the parking brake 117. In at least one example embodiment, the power distribution unit 125 may be coupled to the parking brake 117 by coupling the low voltage distribution unit 127 to a parking brake controller 240. In at least one example embodiment, the motor 115 may be coupled to the high voltage distribution unit 128 of the power distribution unit 125.

In at least one example embodiment, the parking brake 117 may be coupled to factory differentials and axels 250 of the vehicle.

In at least one example embodiment, the battery 120 may be coupled to the high voltage distribution unit 128 and may include the controller 122 as described above. The battery 120 may be a high voltage battery known in the art and may be selected for a particular vehicle and/or retrofit powertrain kit 100.

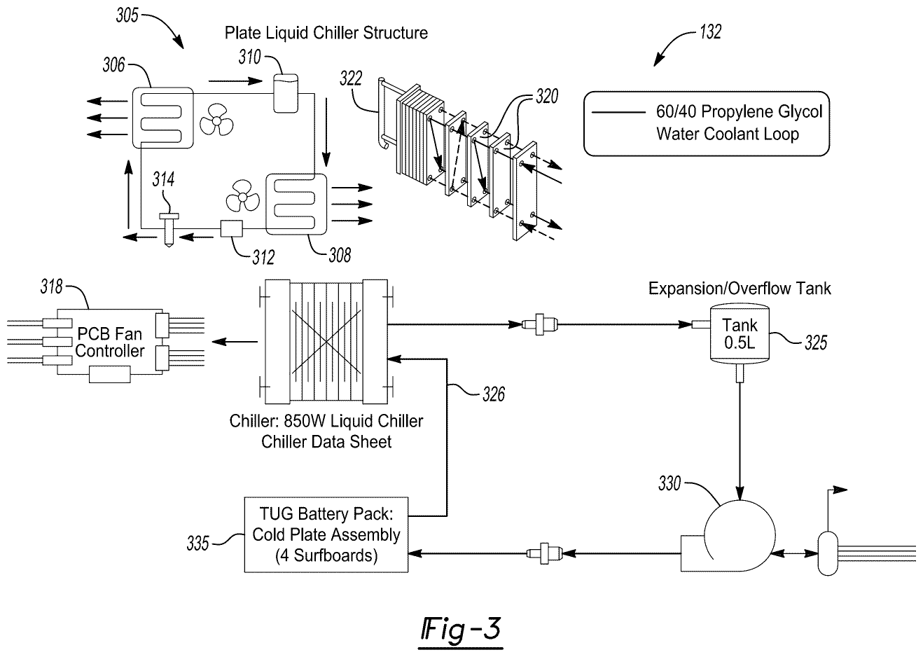

FIG. 3 illustrates an example embodiment of the coolant preconditioning system 132 according to at least one example embodiment. The coolant preconditioning system 132 may include a liquid chiller 305 that may include an evaporator 306, a condenser 308, a compressor 310 coupled between the evaporator 306 and the condenser 308, a drier 312 and an expansion valve 314 coupled between the condenser 308 and the evaporator 306, and a blower fan 316. In at least one example embodiment, the liquid chiller 305 may also include a fan controller 318 configured to control operation of the blower fan 316. In at least one example embodiment, the evaporator 306 may be a plate evaporator that includes one or more metal plates 320 coupled within a frame 322.

The liquid chiller 305 may be coupled to an expansion and overflow tank 325. In at least one example embodiment, the liquid chiller 305 may be coupled to the expansion and overflow tank 325 via a hose such as a 1/2 inch inner diameter (ID) hose and/or a 3/4 inch ID hose. In at least one example embodiment, a first hose may be coupled to a second hose via a hose adapter to couple a ½ inch ID hose to a ¾ inch ID hose. In at least one example embodiment, the expansion and overflow tank 325 may be 0.5 L tank.

The expansion and overflow tank 325 may be coupled to a pump 330. In at least one example embodiment, the expansion and overflow tank 325 may be coupled to the pump 330 via a hose such as a ¾ inch ID hose. In at least one example embodiment, the pump 330 may be a Tengam 2100A Cascadia Motion Kit pump.

The pump 330 may be coupled to a tug battery pack 335. In at least one example embodiment, the pump 330 may be coupled to the tug battery pack 335 via a hose such as a ½ inch ID hose and/or a ¾ inch ID hose. In at least one example embodiment, a first hose may be coupled to a second hose via a hose adapter to couple a ½ inch ID hose to a ¾ inch ID hose. In at least one example embodiment, the tug battery pack 335 may be at least a portion of the battery 120 such as the one or more BMS monitor boards 256.

The coolant preconditioning system 132 may be configured to cool and/or heat the retrofit powertrain kit 100 such that the retrofit powertrain kit 100 maintains an optimal temperature for operating the vehicle.

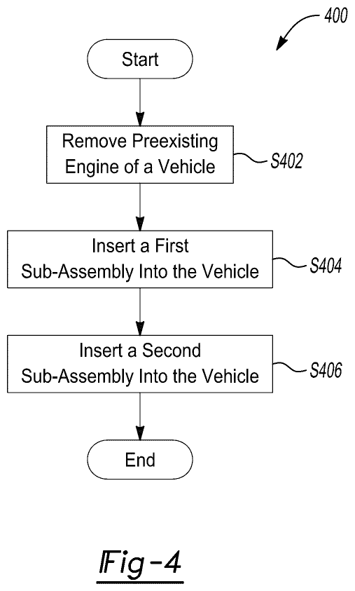

FIG. 4 is a flow chart of a method 400 of installing a retrofit powertrain kit into a vehicle. The method 400 will be described with reference to the retrofit powertrain kit 100 described herein.

At S402, a preexisting engine of a vehicle may be removed. The preexisting engine may be a diesel or gas powered engine that will be replaced by the retrofit powertrain kit 100.

At S404, the first sub-assembly 105 may be inserted into the vehicle. The first sub-assembly 105 may include the motor 115 which may be configured to couple to the factory drivetrain of the vehicle.

At S406, the second sub-assembly 110 may be inserted into the vehicle. The second sub-assembly 110 may include the battery 120 and the power distribution unit 125. The power distribution unit 125 may be configured to power the battery 120 and one or more additional components of the vehicle. In at least one example embodiment, the order of installation of the first sub-assembly 105 and the second sub-assembly 110 may be reversed or the sub-assemblies may be installed simultaneously.

In at least one example embodiment, the method 400 may further include incorporating the coolant preconditioning system 132 into the retrofit powertrain kit 100. As described above, the coolant preconditioning system 132 may be configured to cool at least a portion of the retrofit powertrain kit 100 via liquid cooling.

In at least one example embodiment, the method 400 may further include charging the battery 120 of the second sub-assembly 110 via one of the first charging port 135 or the second charging port 140.

In at least one example embodiment, the method 400 may further include determining a status of the installation of the retrofit powertrain kit 100 into the vehicle and outputting the status of the installation of the retrofit powertrain kit 100. In at least one example embodiment, the controller 122 of the battery 120 may be configured to determine the status of the installation of the retrofit powertrain kit 100 into the vehicle.

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

### NON-LIMITING ILLUSTRATIVE EMBODIMENTS

The following is a list of non-limiting illustrative embodiments disclosed herein:

Illustrative embodiment 1 includes a retrofit powertrain kit for a vehicle. The retrofit powertrain kit comprises a first sub-assembly including a motor, the first sub-assembly configured to couple to a factory drivetrain of the vehicle; and a second sub-assembly including a battery and a power distribution unit. The power distribution unit is configured to couple the second sub-assembly to the first sub-assembly, and the power distribution unit is configured to provide power to the battery and one or more additional components of the vehicle.

Illustrative embodiment 2 includes the retrofit powertrain kit of illustrative embodiment 1, wherein the first sub-assembly further includes a parking brake and the first sub-assembly is configured to couple to the factory drivetrain via the parking brake.

Illustrative embodiment 3 includes the retrofit powertrain kit of illustrative embodiment 1, further comprising: a coolant preconditioning system configured to cool at least a portion of the retrofit powertrain kit via liquid cooling.

Illustrative embodiment 4 includes the retrofit powertrain kit of illustrative embodiment 1, wherein the battery includes a controller configured to control the vehicle.

Illustrative embodiment 5 the retrofit powertrain kit of illustrative embodiment 1, further comprising: a first charging port; and a second charging port. The first charging port is configured for DC charging and the second charging port is configured for AC charging.

Illustrative embodiment 6 includes the retrofit powertrain kit of illustrative embodiment 1, wherein the power distribution unit includes a motor controller, a low voltage distribution unit, a high voltage distribution unit, and a charger.

Illustrative embodiment 7 the retrofit powertrain kit of illustrative embodiment 1, further comprising at least one controller configured to determine an installation status of the retrofit powertrain kit within the vehicle.

Illustrative embodiment 8 the retrofit powertrain kit of illustrative embodiment 7, wherein the at least one controller is configured to communicate with an interface to output an indication of the installation status of the retrofit powertrain kit within the vehicle.

Illustrative embodiment 9 includes the retrofit powertrain kit of illustrative embodiment 1, wherein the battery is a high voltage battery and the retrofit powertrain kit further includes at least one low voltage battery configured to provide power to low voltage components of the vehicle.

Illustrative embodiment 10 includes a method of installing a retrofit powertrain kit into a vehicle. The method comprises: removing a preexisting engine of the vehicle; inserting a first sub-assembly of the retrofit powertrain kit into the vehicle, the first sub-assembly including a motor configured to couple to a factory drivetrain of the vehicle; and inserting a second sub-assembly of the retrofit powertrain kit into the vehicle, the second sub-assembly including a battery and a power distribution unit, the power distribution unit configured to power to the battery and one or more additional components of the vehicle.

Illustrative embodiment 11 includes the method of illustrative embodiment 10, wherein the first sub-assembly of the retrofit powertrain kit further includes a parking brake.

Illustrative embodiment 12 includes the method of illustrative embodiment 11, wherein inserting the first sub-assembly of the retrofit powertrain kit into the vehicle includes coupling the parking brake to the factory drivetrain.

Illustrative embodiment 13 includes the method of illustrative embodiment 10, further comprising: incorporating a coolant preconditioning system into the retrofit powertrain kit, the coolant preconditioning system being configured to cool at least a portion of the retrofit powertrain kit via liquid cooling.

Illustrative embodiment 14 includes the method of illustrative embodiment 10, further comprising: charging the battery of the second sub-assembly via one of a first charging port or a second charging port, the first charging port being an AC charging port and the second charging port being a DC charging port.

Illustrative embodiment 15 includes the method of illustrative embodiment 10, further comprising: determining a status of installation of the retrofit powertrain kit within the vehicle.

Illustrative embodiment 16 includes the method of illustrative embodiment 15, further comprising: outputting the status of the installation of the retrofit powertrain kit.

We claim:

1. A retrofit powertrain kit for a vehicle, the retrofit powertrain kit comprising:
a first sub-assembly including a motor, the first sub-assembly configured to couple to a factory drivetrain of the vehicle; and
a second sub-assembly including a battery and a power distribution unit, wherein
the power distribution unit is configured to couple the second sub-assembly to the first sub-assembly, and
the power distribution unit is configured to provide power to the battery and one or more additional components of the vehicle.

2. The retrofit powertrain kit of claim 1, wherein the first sub-assembly further includes a parking brake and the first sub-assembly is configured to couple to the factory drivetrain via the parking brake.

3. The retrofit powertrain kit of claim 1, further comprising:
a coolant preconditioning system configured to cool at least a portion of the retrofit powertrain kit via liquid cooling.

4. The retrofit powertrain kit of claim 1, wherein the battery includes a controller configured to control the vehicle.

5. The retrofit powertrain kit of claim 1, further comprising:
a first charging port; and
a second charging port, wherein
the first charging port is configured for DC charging and the second charging port is configured for AC charging.

6. The retrofit powertrain kit of claim 1, wherein the power distribution unit includes a motor controller, a low voltage distribution unit, a high voltage distribution unit, and a charger.

7. The retrofit powertrain kit of claim 1, further comprising:
at least one controller configured to determine an installation status of the retrofit powertrain kit within the vehicle.

8. The retrofit powertrain kit of claim 7, wherein the at least one controller is configured to communicate with an interface to output an indication of the installation status of the retrofit powertrain kit within the vehicle.

9. The retrofit powertrain kit of claim 1, wherein the battery is a high voltage battery and the retrofit powertrain kit further includes at least one low voltage battery configured to provide power to low voltage components of the vehicle.

10. A method of installing a retrofit powertrain kit into a vehicle, the method comprising:
removing a preexisting engine of the vehicle;
inserting a first sub-assembly of the retrofit powertrain kit into the vehicle, the first sub-assembly including a motor configured to couple to a factory drivetrain of the vehicle; and
inserting a second sub-assembly of the retrofit powertrain kit into the vehicle, the second sub-assembly including a battery and a power distribution unit, the power distribution unit configured to power to the battery and one or more additional components of the vehicle.

11. The method of claim 10, wherein the first sub-assembly of the retrofit powertrain kit further includes a parking brake.

12. The method of claim 11, wherein inserting the first sub-assembly of the retrofit powertrain kit into the vehicle includes coupling the parking brake to the factory drivetrain.

13. The method of claim 10, further comprising:
incorporating a coolant preconditioning system into the retrofit powertrain kit, the coolant preconditioning system being configured to cool at least a portion of the retrofit powertrain kit via liquid cooling.

14. The method of claim 10, further comprising:
charging the battery of the second sub-assembly via one of a first charging port or a second charging port, the first charging port being an AC charging port and the second charging port being a DC charging port.

15. The method of claim 10, further comprising:
determining a status of installation of the retrofit powertrain kit within the vehicle.

16. The method of claim 15, further comprising:
outputting the status of the installation of the retrofit powertrain kit.
